(19) United States
(12) Patent Application Publication
(10) Pub. No.: US 2006/0085281 A1
(43) Pub. Date: Apr. 20, 2006

(54) Online shopping system and method

(76) Inventors: Atsushi Hanai, Kanagawa (JP); Masayuki Nishimoto, Kanagawa (JP); Fusakichi Ohkouchi, Kanagawa (JP); Tsukasa Fukudome, Kanagawa (JP); Tatsuto Torikai, Kanagawa (JP); Hiroshi Hosoda, Kanagawa (JP); Yasuyuki Shirai, Tokyo (JP); Eiji Shinohara, Kanagawa (JP); Akihiro Nishida, Tokyo (JP); Sachiko Misumi, Tokyo (JP); Takuya Higashimae, Kanagawa (JP); Yoshiaki Ohno, Kanagawa (JP); Keisuke Kataoka, Tokyo (JP); Shizuo Kamimura, Tokyo (JP)

Correspondence Address: DICKSTEIN SHAPIRO MORIN & OSHINSKY LLP, 2101 L Street, NW, Washington, DC, 20037, US

(21) Appl. No.: 11/250,366

(22) Filed: Oct. 17, 2005

Related U.S. Application Data
(62) Division of application No. 09/805,912, filed on Mar. 15, 2001.

(30) Foreign Application Priority Data
Mar. 16, 2000 (JP) 2000-73679
Mar. 16, 2000 (JP) 2000-73684
Mar. 16, 2000 (JP) 2000-73690
Mar. 16, 2000 (JP) 2000-73693
Mar. 8, 2001 (JP) 2001-64347

(51) Int. Cl. G06Q 30/00

(52) U.S. Cl. 705/26

(57) ABSTRACT

There is provided a network shopping system that contributes to the omission of the item to be purchased and the prevention of purchasing an unnecessary item. Information of equipment that each client possesses is stored in net member DB. A main item, an option, or an item having a tendency to be used at the same time, are associated with an item related thereto and stored in related item DB. When a user inputs individual identification information for authentication processing, the system searches net member DB to specify equipment that the user possesses. Next, the system gains access to related item DB, searches a related item, and recommends the item to the user.

### BACKGROUND OF THE INVENTION

1. Field of the Invention

The present invention relates to a system and a method for recommending related items to clients. The present invention also relates to an online shopping system and method.

2. Description of the Related Art

In accordance with the development of the Internet, online shopping has increasingly sprung into wide use. In a known online shopping system, a user visits a home page that sells items, selects items on the home page, and inputs payment information. In the known online shopping system, it is necessary for the user to decide on an item to be purchased, conduct a search, and order the purchase on an unfamiliar homepage. Common users do not always have sufficient knowledge about all items and the home page. For example, at the time of purchasing a main item, there is a case in which an option of the item and consumable items must be purchased at the same time with the main item or a case in which they are desirably purchased at the same time. However, the user may not order such an option and consumable items without noticing them. Conversely, there is a case in which the user erroneously orders an unnecessary item.

Even if the user decides on the item to be ordered, the user may have difficulty finding the item on the home page, depending on the circumstances. At a store, in a door-to-door selling situation, or the like, the client can obtain advice from the salesperson. In the case of online shopping, however, such service is not available, and this renders the online shopping inconvenient for the user. Advice obtained from the store or the door-to-door salesperson was general, and it was difficult for the client to obtain high quality and uniform advice. Moreover, information obtained from the general sales networks (sales store networks, service networks) and information obtained via online shopping systems were not organically linked by even the enterprise having the normal sales networks, and the use of information was insufficient.

The way of payment via online shopping includes a credit card and a transfer, while the way of payment for normal business transactions includes a bill, cash, and a transfer as mainstream. This cases a problem in which accounting treatment at the company becomes complicated in terms of settlement.

The present invention has been made with consideration given to the aforementioned problems, and an object of the present invention is to provide an online shopping system with high convenience.

Another object of the present invention is to provide an online shopping system that is capable of making full use of client information.

Still another object of the present invention is to provide a system that is capable of performing payment efficiently.

### SUMMARY OF THE INVENTION

In order to attain the above object, according to a first aspect of the present invention, there is provided a related item recommending system comprising: a related information storing memory which stores a plurality of items and items relating to the respective items to be associated with each other, and a controller which accepts specification of a purchase target item, and searches an item related to the purchase target item from the related information storing memory when accepting the purchase target item.

According to a second aspect of the present invention, there is provided a related item recommending method comprising: defining related information of a plurality of items; accepting selection and/or purchase order of an item from a client via a network; determining a related item relating to the accepted item based on the related information; offering the determined related item to the client via the network; and accepting purchase order of the offered item.

According to a third aspect of the present invention, there is provided a program for controlling a computer (or a group of computers) to perform: accepting specification of a purchase target item; and searching an item related to the purchase target item from a memory which stores a plurality of items and items relating to the respective items to be associated with each other when accepting the purchase target item.

According to a fourth aspect of the present invention, there is provided an item recommending system capable of recommending a related item at the time of purchasing an item, comprising: a client database which stores an item that a client possesses; a related information storing memory which stores an item and other item related to the item to be associated with each other, a possessed item exactor which specifies a client to extract the item that the client possesses from the client database; a related item extractor which extracts an item related to the item extracted by the possessed item extractor from information stored in the related information storing memory, and a recommendation section which recommends the purchase of the item extracted by the related item extractor.

According to a fifth aspect of the present invention, there is provided an online shopping system that is capable of reflecting a discount rate which is used in a business transaction at a store, comprising: a client database which records information of a client; a discount memory which registers discount information, corresponding to a price discount rate used in the business transaction at the store, onto the client data base; and a controller which sets a price of an item offered to the client as a purchase target to a value that reflects discount information set in the client database.

According to a sixth aspect of the present invention, there is provided an item recommending method comprising the steps of: defining related information of a plurality of items; storing client information indicative of an item that each client possesses; specifying a client of an access source in response to access via a network; specifying a possessed item that the specified client possesses; determining a related item of the specified possessed item from the related information; offering the determined related item via the network; and accepting an order corresponding to the offer.

According to a seventh aspect of the present invention, there is provided a method comprising the steps of registering discount information corresponding to a price discount rate used in a business transaction at a sales store; specifying a client of an access source in response to access via a network; specifying a price discount rate of an item offered to the specified client from the discount information; and setting a price of an item offered to the client as a purchase target to a value that reflects the specified price discount rate.

According to an eighth aspect of the present invention, there is provided a program for controlling a computer to perform: extracting an item that a client possesses from a client database for storing the client's possessed item; extracting an item relating to the extracted item from a related information database for storing an item and other item relating to the item to be associated with each other, and outputting a signal for recommending the purchase of the extracted item to the client

According to a ninth aspect of the present invention, there is provided a program for controlling a computer to perform: specifying a client of an access source in response to access via a network from a server in an online shopping system; setting a discount rate of an item offered to the specified client to a price discount rate in a business transaction at a sales store; and setting a price of an item offered to the client as a purchase target to a price that reflects the set price discount rate to generate a signal for offering the set value to the client.

According to a tenth aspect of the present invention, there is provided a selection supporting apparatus for a subordinate item comprising: an item information storing memory which classifies a plurality of items into an item classification indicative of main items and subordinate items subordinate to the main items to divide the main items into a plurality of item categories to be related to each other and stored; a specifier which specifies an item classification of a desired item and an item category of the main item; a display unit or device which displays a list of main items belonging to the item category specified by the specifier, a selector for selecting an arbitrary main item from the list; and an extractor which extracts an item applicable to the main item selected by the selector and belonging to the item classification specified by the specifier from the item information storing memory.

According to an eleventh aspect of the present invention, there is provided a method for selecting a subordinate item comprising the steps of selecting an item classification; offering a first list of item categories of main items in response to the selection of the item classification; accepting the selection of the item category from the offered first list; offering a second list of the main items belonging to the selected category in response to the selection of the item category, accepting the selection of the main item from the offered second list; and extracting an item applicable to the selected item and belonging to the selected item classification in response to the selection of item from an item information database that classifies a plurality of items into item classifications indicative of main items and subordinate items subordinate to the main items and divides the main items into a plurality of item categories and stores the man items to be associated with each other.

According to a twelfth aspect of the present invention, there is provided a program for controlling a computer to perform: specifying an item category and an item classification, respectively; displaying a list of items belonging to the item category specified by the specifying means; selecting an arbitrary item from the list; and extracting an item applicable to the selected item and belonging to the selected item classification in response to the selection of item from an item information database that classifies a plurality of items into item classifications indicative of main items and subordinate items subordinate to the main items and divides the main items into a plurality of item categories and stores the main items to be associated with each other.

According to a thirteenth aspect of the present invention, there is provided a network system comprising: a memory which stores identification information of a business organization and identification information of at least one individual belonging to the business organization; an inputting section which inputs identification information of the business organization and identification information of individual belonging to the business organization at a log in time via a network; a determiner which determines whether or not a pair of identification information of the business organization and identification information of individual correspond to information registered in the storing means; and a discriminator which discriminates whether log-in is accepted or rejected in accordance with a result of the determination.

According to a fourteenth aspect of the present invention, there is provided a log-in method comprising the steps of inputting identification information of a business organization and identification information of individual belonging to the business organization at a log-in time via a network; determining whether or not a pair of input identification information of the business organization and identification information of individual is registered as a person who can log in; and deciding whether log-in is accepted or rejected in accordance with the determination result.

According to a fifteenth aspect of the present invention, them is provided a program causing a computer to execute: processing for inputting identification information of a business organization and identification information of an individual belonging to the business organization at a log-in time via a network; determining whether or not a pair of input identification information of the business organization and identification information of individual is registered as a person who can log in; and deciding whether log-in is accepted or rejected in accordance with the determination result

### BRIEF DESCRIPTION OF THE DRAWINGS

These objects and other objects and advantages of the present invention will become more apparent upon reading of the following detailed description and the accompanying drawings in which:

FIG. 1 is a view illustrating the configuration of a sales online shopping system according to an embodiment of the present invention;

FIG. 2 is a view illustrating the configuration of a store terminal installed at each store and that of a store DB;

FIG. 3A is a view illustrating the configuration of a client DB in the store DB, FIG. 3B is a view illustrating the configuration of a sales DB in the store DB, and FIG. 3C is a view illustrating the configuration of a bill DB in the store DB;

FIG. 4 is a view illustrating the configuration of a management server and that of management DB;

FIG. 5A is a view illustrating the configuration of an item master DB in the management DB, FIG. 5B is a view illustrating the configuration of a client master DB in the management DB, and FIG. 5C is a view illustrating the configuration on of a related item master DB in the management DB;

FIG. 6 is a view illustrating the configuration of a shopping server and that of a shopping DB;

FIG. 7 is a view illustrating the configuration of a net member DB in the shopping DB;

FIG. 8 is a view illustrating an example of a log-in screen page for an online shopping that the shopping server provides;

FIG. 9 is a flowchart to explain processing that the shopping server executes at the time of logging in;

FIG. 10 is a view illustrating an example of a page, which is edited for a client and is displayed after logging in;

FIG. 11 is a view illustrating an example of a screen page for selecting a main item via the online shopping;

FIG. 12 is a view illustrating an example of a screen page for selecting a copy machine via the online shopping,

FIG. 13 is a view illustrating an example of a screen page for selecting an option via online shopping,

FIG. 14 is a view illustrating an example of a screen page for selecting a consumable item via the online shopping,

FIG. 15 is a view illustrating an example of a screen page for selecting an option for a digital camera whose item classification is a main item via the online shopping,

FIG. 16 is a flowchart illustrating one example of processing that the shopping server executes when an item is put in a shopping cart via the online shopping;

FIG. 17 is a view illustrating one example of a screen page forming the content of the shopping cart;

FIG. 18 is a view illustrating one example of a screen page for recommending related items via the online shopping;

FIG. 19 is a view to explain the configuration of the net member DB according to a second embodiment of the preset invention;

FIG. 20 is a flowchart to explain the operation of the shopping server according to the second embodiment of the present invention;

FIG. 21 is a flowchart to explain the operation of the shopping server according to the second embodiment of the present invention;

FIG. 22 is a view illustrating an example of a display page for which an attribute is a general user according to the second embodiment of the present invention;

FIG. 23 is a view illustrating an example of a display page for which an attribute is a person in charge of order according to the second embodiment of the present invention;

FIG. 24 is a view illustrating an example of a display page for which an attribute is a manager of order according to the second embodiment of the present invention;

FIG. 25 is a view illustrating a display example of an item purchase history list,

FIG. 26 is a view illustrating a display example of a consumable item purchase history list;

FIG. 27 is a view illustrating an example of a display page for which an attribute is managerial staff according to the second embodiment of the present invention;

FIG. 28 is a view illustrating an example of a display page on which a user can control the weight of display content; and

FIG. 29 is a view illustrating the configuration example of the net member DB such that user can control the weight of display content

### DETAILED DESCRIPTION OF PREFERRED EMBODIMENTS

### First Embodiment

A sales system according to embodiments of the present invention will be specifically described with reference to the accompanying drawings.

This system is one that is capable of promoting network shopping service while maintaining and developing the existing sales store networks.

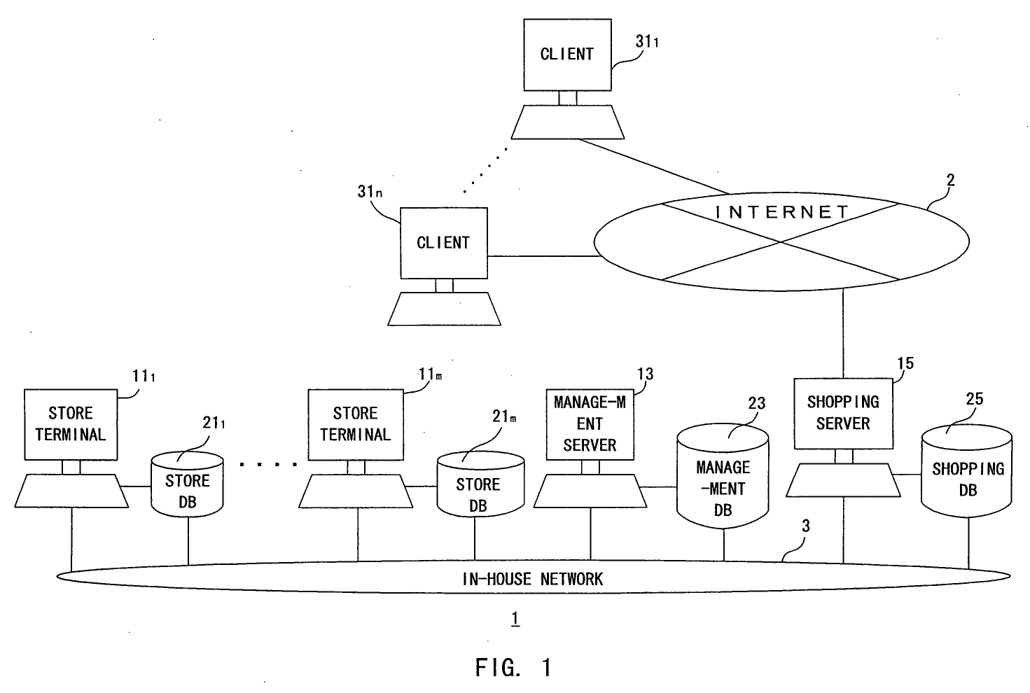

FIG. 1 is a view schematically illustrating the configuration of a network system according to a first embodiment of the present invention. As illustrated in FIG. 1, this system comprises an in-house network system 1 that a business organization such as an enterprise, a group, etc., possesses, the Internet 2 that is open to the public, and client terminal (client terminals) (31₁ to 31ₘ) connected to the Internet 2.

The in-house network system 1 is composed of an intranet, and the in-house network system 1 comprises a plurality of store terminals 11 (11ₗ, to 11ₘ), store DBs 21 (21₁ to 21ₘ), a management server 13, a management DB 23, a shopping server 15, a shopping DB 25, which are interconnected via an in-house network (LAN, WAN) 3. The store terminals 11 are installed in the stores (which includes sales stores, service store, shops, centers, any contracted bases, and the like) that the business organization possesses or contacts with to process business operations of the respective store.

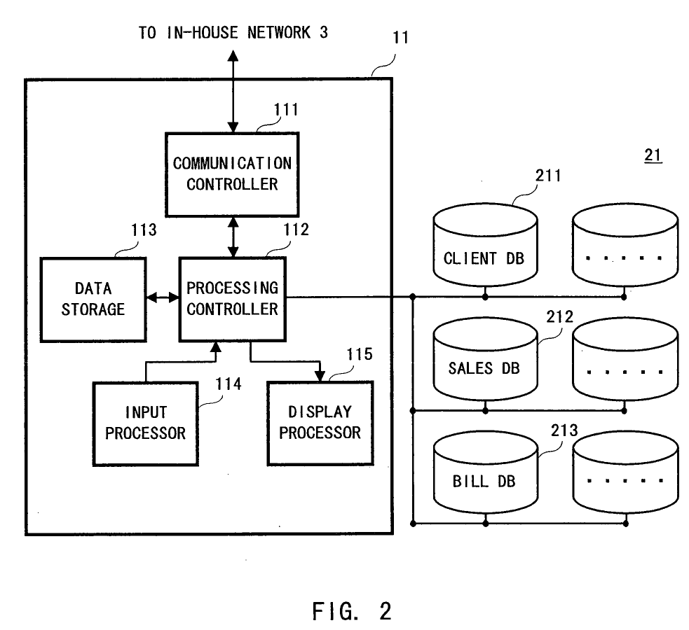

The store DBs 21 are used to process the business operations of the respective stores. The store terminals 11 and store DBs have the configuration as illustrated in FIG. 2. As illustrated in FIG. 2, each store terminal 11 comprises a communication controller 111, a processing controller 112, a data storage 113, an input processor 114, and a display processor 115. The communication controller 111 receives/transmits various kinds of information via the in-house network 3 by control of the processing controller 112.

The processing controller 112 performs communications via the communication controller 111 in accordance with an instruction inputted from the input processor 114 and processes various kinds of information relating to the business operations of the store. The communication controller 111 also generates image information, and supplies it to the display processor 115.

The data storage 113 is composed of a semiconductor memory, a magnetic disk recording device and the like, and stores various kinds of information and programs. The input processor 114 is composed of a keyboard, a pointing device and the like, and inputs instruction and data. The display processor 115 is composed of a display unit, a video memory, and the like, and displays an image, which is based on image information sent from the processing controller 112, and outputs information.

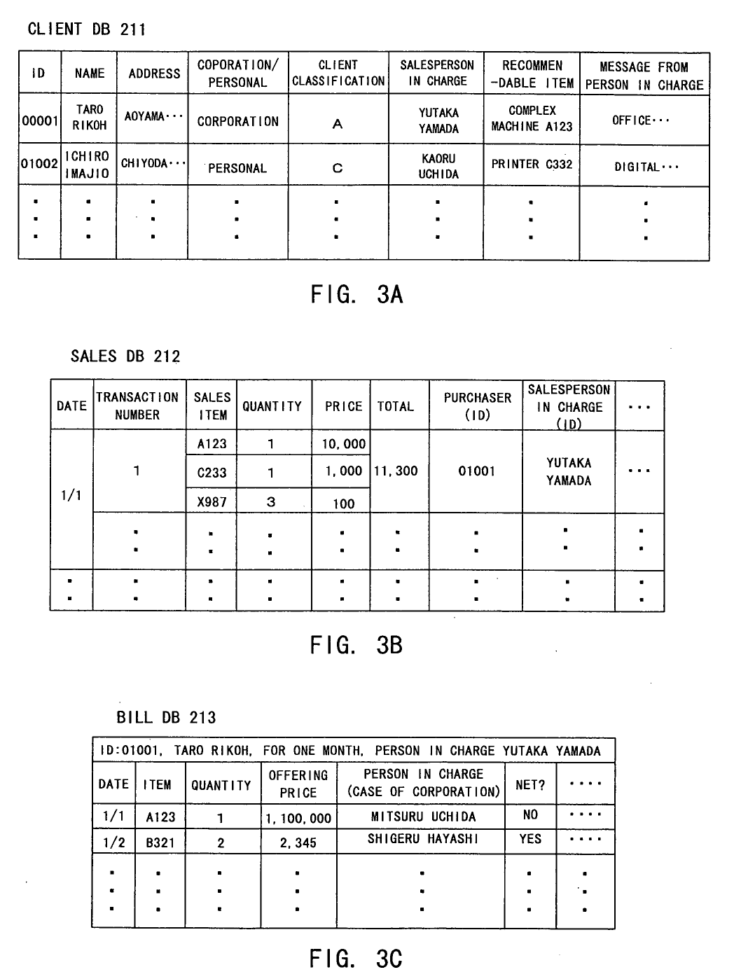

Each store DB 21 includes a client DB 211, a sales DB 212, and a bill DB 213. The client DB 211 stores basic information relating to clients that each store has as illustrated in FIG. 3A. Namely, the basic information includes a client ID, a name, an address, a distinction between corporation and individual, a client classification, a salesperson in charge, a recommendable item, and a message from the salesperson in charge. The client ID herein refers to client identification information where unique information is stored according to the client. The client classification indicates degree of the client quality. The discount rate of the item price and a coupon with respect to the client is decided according to the client classification. The client classification is set by, for example, the salesperson in charge. Regarding the recommendable item, the salesperson in charge sets an item that the salesperson in charge wishes to recommend to the client. Regarding the message from the salesperson in charge, the person in charge sets a short message.

The sales DB 212 stores an item code, quantity, price, a purchaser code, a code for salesperson in charge, and the like on a single business transaction basis in connection with the sold item as illustrated in FIG. 3B. Since sales information is recorded on a single business transaction basis, an item (item group) purchased at the same time can be judged therefrom. The bill DB 213 stores one-month bill information and issues a bill as illustrated in FIG. 3C. Namely, the bill information includes sales date, a sales item, quantity; price (offering price), a salesperson in charge (in the case of a corporation), and the like. In this system, even if the corporation purchases the item via online shopping over the Internet, the store in charge issues the bill at one time. Regarding the sale via the online shopping, the similar information is set, and a flag (net? YES, NO) indicative of the sale at the online shopping is set.

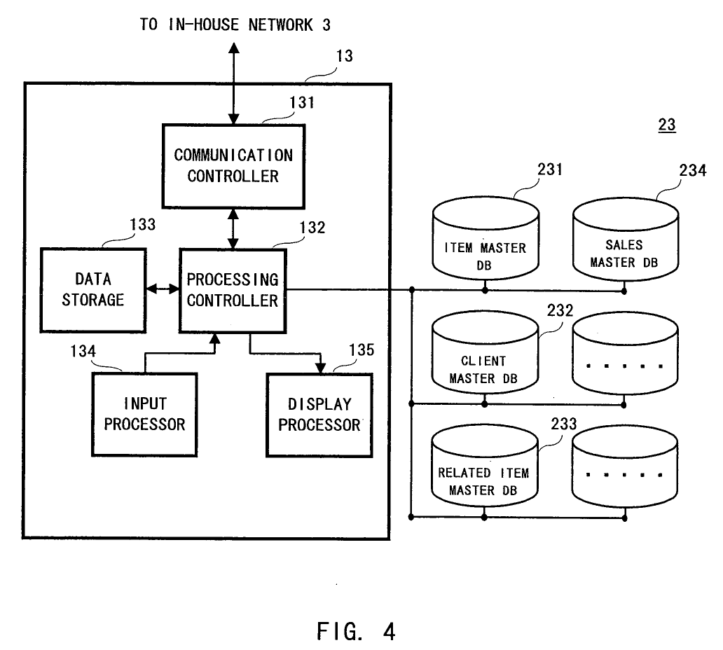

The management server 13 and management DB 23 illustrated in FIG. 1 are computer systems for processing the business operations of the overall business organization. The management server 13 comprises a communication controller 131, a processing controller 132, a data storage 133, an input processor 134, and a display processor 135 as illustrated in FIG. 4. These components are fundamentally the same as the communication controller 111, the processing controller 112, the data storage 113, the input processor 114, and the display processor 115, which are provided in the store terminal 11 in terms of the configuration and function. It is noted that the function of the processing controller 132 is specialized to perform processing for the management business of the overall business organization.

The management DB 23 is used to accumulate and manage various kinds of data of the overall business organization. As illustrated in FIG. 4, the management DB 23 includes an item master DB 231, a client master DB 232, a related item master DB 233, and a sales master DB 234. The item master DB 231 stores an item code relating to all items, which the business organ on handles, an item name, a content of item explanation, a reference price, an item classification, and link information.

The item classification herein refers to information indicating which of “main item, “option,” and consumable item” the target item belongs to. The “main item” means the primary item, which is singly used. The “option” means the item which is attached/connected to the main item without being used singly. The “consumable item” is generally attached to the main item or the option without being used singly, and its amount is reduced in accordance with the use thereof. A copy machine is taken as an example. In this example, the copy machine itself is a main item. A feeder, a sorter, a communication apparatus, and a power source apparatus, which are attached to the copy machine, are options. Toner and paper for PPC (Plain Paper Copier) are consumable items. Moreover, a digital camera is taken as an example. In this example, a camera itself is a main item, a cable and communication software that connects the camera to a personal computer are options, and a flash memory card that stores images and a battery are consumable items.

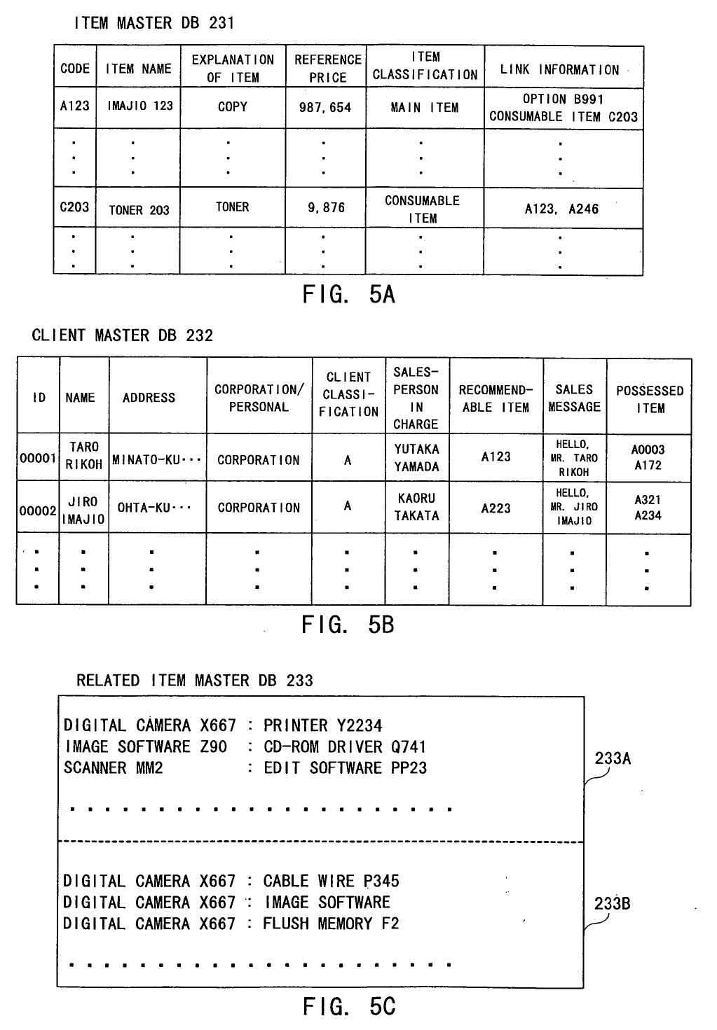

Link information is another item classification, and one that is applicable to the item is registered. For example, in the case of “main item,” the item code of the option applicable to the main item and that of the consumable item applicable thereto are registered. Similarly, in the case of “option,” the item code of the main item applicable to the option and that of the consumable item applicable thereto are registered. Also, in the case of “consumable item,” the item code of the consumable item applicable to the main item and that of the option applicable thereto are registered. In the example illustrated in FIG. 5A, C203 is named as a consumable item applicable to the item with item code A123 that is the main item. In other words, the applicable main item of A123 is named as link information of item code C203.

The respective items are classified into any one of item classifications based on the item classification and link information, and the items whose applicable relationship is established are linked to each other. The designation of the model of main item allows the specification of the option or consumable item that is applicable to the main item, making it possible to select designate the item. Also, the specification of the item classification makes it possible to select/designate the item that is applicable to a certain item with the item classification.

The client master DB 232 stores client information relating to all clients of the enterprise. As illustrated in FIG. 5B, the content thereof is similar to that of the client DB 211 illustrated in FIG. 3A. It is noted that information of the item (apparatus), which each client possesses, is also recorded thereon.

The related it master DB 233 stores items that are very likely to be purchased at the same time or desirably purchased at the same time as illustrated in FIG. 5C. For example, there is some relation among a certain item, the option, and the consumable item. Moreover, it is desirable that software for editing/processing a projected image and a printer for printing the processed image be purchased at the time of purchasing the digital camera. Namely, they are related items. In a case where the relation among the items is clear in advance, the person in charge of this system makes an entry of related information of related items in an area 233A of the related item master DB 233 using the input processor 134.

Even if the person in charge of this system does not take notice of the relation, it is desirable that the related item be purchased at the same time in many cases when many people purchase a certain item. For this reason, the processing controller 132 checks a past sales history. When a ratio at which the item is sold at the same time exceeds a predetermined value, for example, 5% or more, the person in charge of this system makes an entry of related information indicative of relation between both items in an area 233B of the related item master DB 233.

In the sales master DB 234, information relating to the sales of the overall business organization, and sales data of all stores are accumulated. The structure is fundamentally the same as the configuration of the sales DB 212 of each store illustrated in FIG. 3B, and sales information is on a single business transaction basis. Accordingly, an item purchased at the same time can be judged from the content of the sales master DB 234.

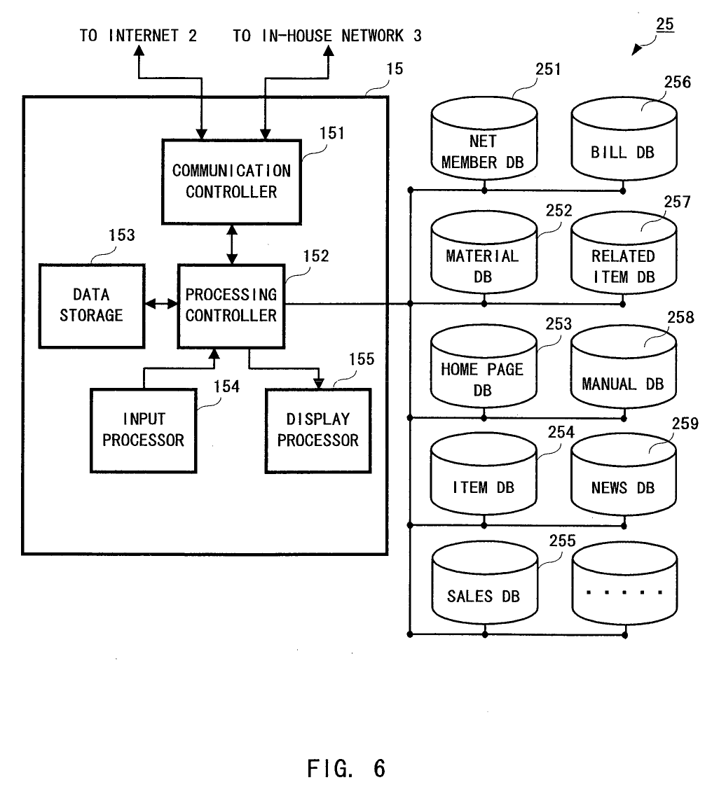

The shopping server 15 and the shopping DB 25 are systems for processing the network shopping (online shopping) over the Internet, and each comprises the configuration as illustrated in FIG. 6. The shopping server 15 comprises a communication controller 151, a processing controller 152, a data storage 153, an input processor 154, and a display processor 155. These components are fundamentally the same as the communication controller 111, the processing controller 112, the data storage 113, the input processor 114, and the display processor 115, which are provided in the store terminal 11 in terms of the configuration and function. It is noted that the function of the processing controller 152 is social to perform processing for the home page management for online shopping and sales processing.

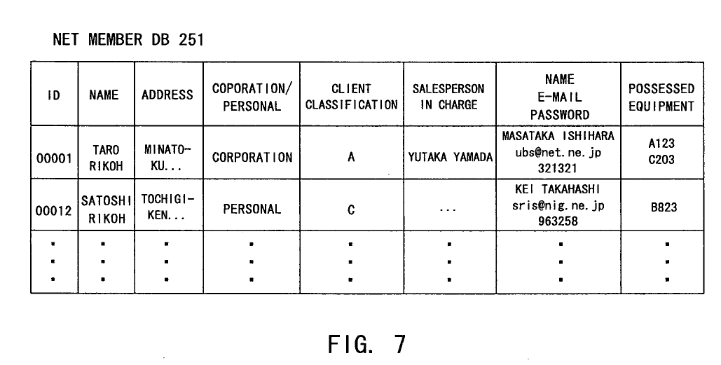

The shopping DB 25 comprises a net member DB 251, a material DB 252, a home page DB 253, an item DB 254, a sales DB 255, a bill DB 256, and a related item DB 257 as illustrated in FIG. 6. The net member DB 251 is a database that stores information relating to members of online shopping (net members). As illustrated in FIG. 7, the information includes an ID, a name/corporation name, an address, a distinction between corporation and individual, a password, and possessed equipment. Moreover, in the case of a corporation, a client classification, a salesperson in charge (store+person in charge), a recommendable item, a message from the salesperson in charge, and the like are stored therein. The ID is member identification information. In the case of a corporation, the same ID used in the sales store/service store is used. The name and address are the name corporation name and address/location. The mail address is an E-mail address of the member. The password is one that is used when the member logs into the online shopping system.

In the case of the corporate member, the mail address and password of each person in charge in the corporation (for example, persons in the general affairs department or purchase department) are registered. The possessed equipment is information of the apples (main body) that the member possesses. In the case of the member who conducts business transactions only via the online shopping, the hems sold via the online shopping in the past are stored in the net member DB 251. In the case of the corporate member who conducts business transactions both at the store and via online shopping, information of the possessed equipment is stored therein based on the histories of both the sale at the store and the online sale. The number of persons in charge may be two or more, and pairs of mail address and password are stored therein according to the number of persons in charge. Regarding information of a client classification, a salesperson in charge of each client, a recommendable item, a message from the salesperson in charge, the same information as stored in the client DB 211 of the store DB 21 is stored therein.

The material DB 252 stores various home pages necessary for providing the online shopping service. The item DB 254 is a database of items that are handled via this online shopping, and has the same configuration as that of the item master DB 231. The sales DB 256 has the same configuration as that of the sales DB 212 of each store (FIG. 3B), and sales information is registered therein on a business, transaction basis.

The bill DB 256 stores billing data relating to the sales via the online shopping. In this system, the bill to the corporate member is issued from the store in charge even if it relates to the sales via online shopping. Accordingly, only billing information of individual members is registered in the bill DB 256. Among related item information registered in the related item master DB 233 of the management DB 23, only information relating to the item that is handled via online shopping is replicated in the related item DB 257.

(Operation)

An explanation will now be given of daily business activities using the above-mentioned system.

(Operation at the Store)

The salesperson in charge at each store makes contact with clients to sell the items, and sales new clients every day. When a new sale (order) occurs, the person in charge at the store registers the comment of the sale (order) in the sales DB 212 of the store DB 21 by the store terminal 11. At this time, the person in charge at the store sets one transaction number regarding a plurality of items handled at the single business transaction. Moreover, when the salesperson seeks a new client, information of the client is registered in the client DB 211. Regarding the corporation that the salesperson takes charge of, the salesperson appropriately sets the client classification (degree of the client quality) of the corporation, recommendable item suitable for the property of the client, and a message to the client and the like.

The management server 13 gains access to the store DB 21 of each sales store and the shopping DB 25 and reads updated information (difference data), and updates the management DB 23. For example, the management server 13 registers same-day sales in the sales master DB 234. In a case where the number of main apparatuses (item whose item classification-corresponds to the main item) that each client possesses is increased, this information is added to the “possessed item” column on the client master DB 232. Moreover, in a case where client information is changed or a new client occurs, management server 13 updates the client master DB 232.

The management server 13 also stores the client classification of a corporate client, recommendable item, the message from the salesperson in charge, and the like in the net member DB 251 of the shopping DB 25 via the shopping server 15. Moreover, the management server 13 generates related item information from the updated content of the sales master DB 234 (generating method will be described later), and stores in the related item master DB 233. Moreover, the management server 13 stores only information relating to the online shopping in the related item DB 257 among updated related item information via the shopping server 15.

(Online Shopping Service)

(Preliminary Registration)

If the corporate client uses the online shopping service, the corporate client must receive registration of the use at the sales office preliminary. The corporate client specifies the person in charge and offers the registration of online shopping through the salesperson in charge. Regarding one corporation, the number of persons in charge may be two or more, and pairs of mail address and password corresponding to the number of persons are specified. Information described in an application for registration is forwarded to the administrator of the shopping server 15, and is registered in, for example, the net DB 251 illustrated in FIG. 7. Information of the client classification is set to a value decided by the salesperson in charge in order to ensure consistency with the service at each sales office. Communication between the salesperson in charge of each store and the administrator of the shopping server 15 is well performed to execute the above-mentioned processing.

On the other hand, the individual client gains access to the home page for registering the member on the Web site that the shopping server 15 manages. Then, the mail address, address/name, way of payment, and the like are registered at the home page for registering the member. The password is issued to the registered individual. The shopping server 15 adds the member ID to the above information, and registers it into the net member DB 251.

(Operation of Online Shopping)

An explanation will be next given of the operation when the online shopping is actually carried out

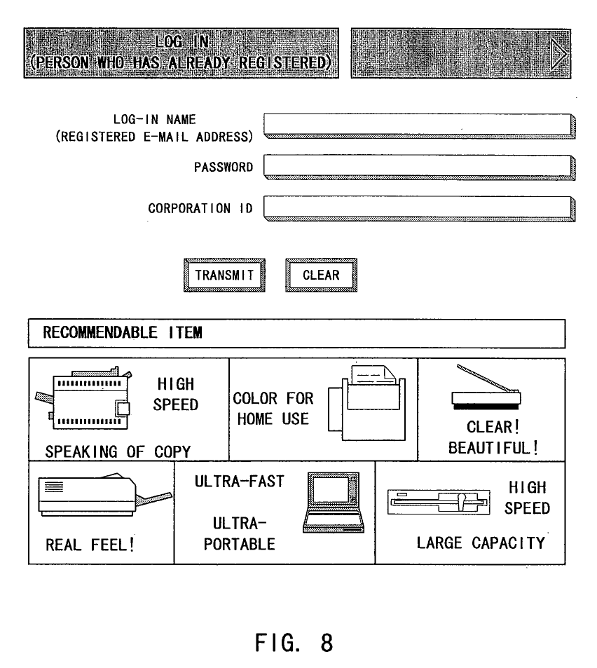

When an arbitrary user gains access to the log-in screen page of the home page that the shopping server provides from the client terminal 31 over the Internet, the shopping server 15 reads a page (information in HTML format) as illustrated in FIG. 8 from the home page DB 253 and transmit it to the client terminal 31. This page has the structure in which input boxes for inputting a log-in name (registered mail address), a password, a corporation ID are provided at the upper frame and advertisement for a recommendable item fixed by the system is displayed at the lower frame.

The user inputs information on this page, and clicks “transmit.” Namely, in the case where the user is the individual the user inputs the mail address and the password, and clicks “transmit.” In the case where the user is a corporation, the user inputs the mail address of the person in charge and the password, and the corporation ID. When the user inputs information and clicks “transmit,” notification of input information is sent to the shopping server 15 over the Internet 2.

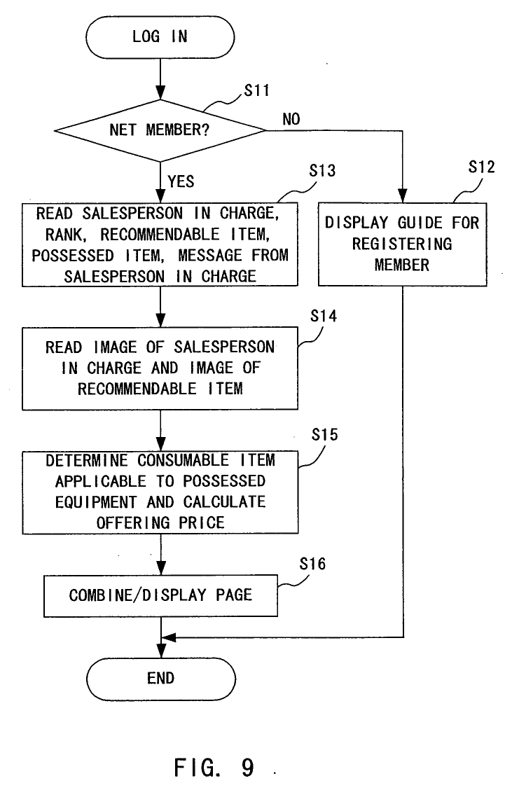

The shopping server 15 starts processing of FIG. 9 in response to notification, and determines whether input information is registered in the net member DB 251 or not (step S11). In the case of the corporate user, the corporation ID is registered, and the pair of input mail address and password must be set in the corporation ID. This specifies the corporation and the person in charge. When no registration is made, information (not shown) of a page (HTML document) for guiding a registration procedure is transmitted to the client terminal 31 to be displayed thereon (step S12).

On the other hand, when the registration is made, the salesperson in charge at the sales office taking charge of this client, the client classification, the possessed equipment, the recommendable item, and the message from the salesperson in charge are read from the net member DB 251 (step S13). Next the image of the salesperson in charge determined in step S13 and the image of the recommendable item are read from the material DB 252 (step S14).

Next, the consumable item, which is applicable to the equipment that the member, who has logged in, possesses, is judged from information of the possessed equipment read in step S13 and related information stored in the related item DB 257. Moreover, information of the consumable item is read from the material DB 252. A discount rate d corresponding to the client classification read in step S13 is obtained, and an offering price considering the discount rate (reference price×(1−d)) is obtained (step S15).

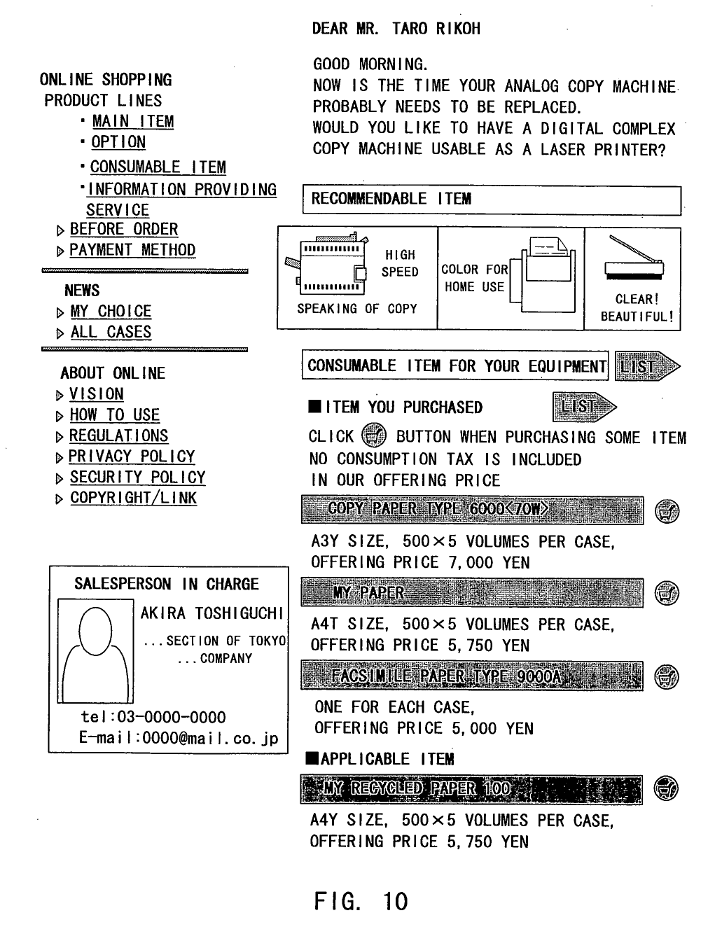

Next, such information is arranged to form an HTML document as illustrated in FIG. 10, and the HTML document is transmitted to the client terminal 31 to be displayed thereon (step S16). The page illustrated in FIG. 10 is divided into four frames, upper left, lower left, upper right, and lower right A table of contents is placed at the upper stage of the left frame, and information of the salesperson in charge of this member is displayed at the lower stage thereof. The message to the client from the salesperson in charge is placed at the upper stage of the right frame and the image of the item recommended to the client by the salesperson in charge is provided thereunder. Information (including offering price) of the consumable items for the apparatus that the client possesses is displayed at the lower stage of the right frame (recommendation of consumable item)

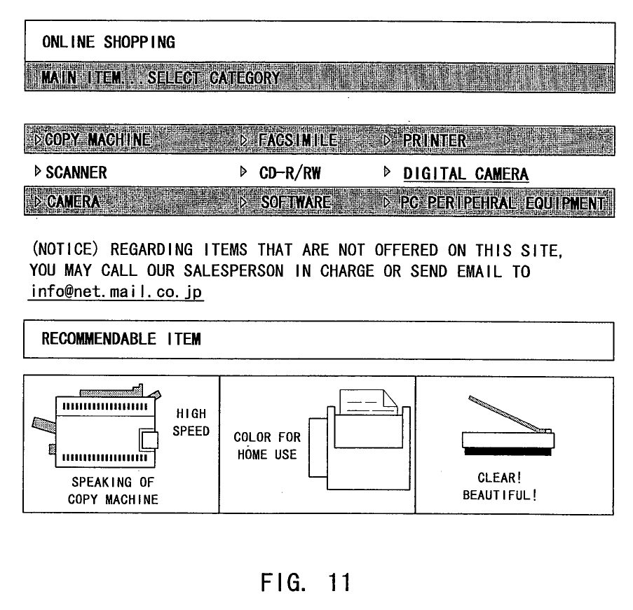

The member can purchase the necessary item using a shopping cart model on this page or after jumping an arbitrary page. For example, if the member selects an arbitrary item from the consumable items that are displayed as recommendable items at the right frame on the page shown in FIG. 10, the shopping server 15 adds the selected item to the so-called shopping cart. When the user wishes to purchase the main item, the user clicks the “main item” at the left frame. The character string of “main item” is linked to a page that displays a list of the main item by the category as illustrate in FIG. 11 to jump the display to this page. Moreover, when the user selects any one of the categories (item categories), the shopping server 15 generates a page for displaying the explanation of the specific item and the offering price to this client (reference price×(1−discount rate)), and transmits the page to the client terminal 31 to be displayed

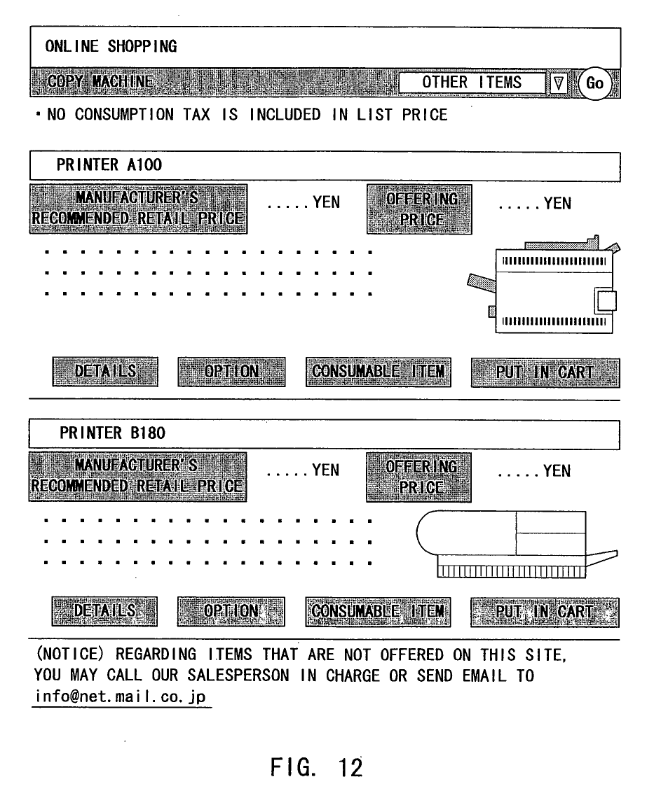

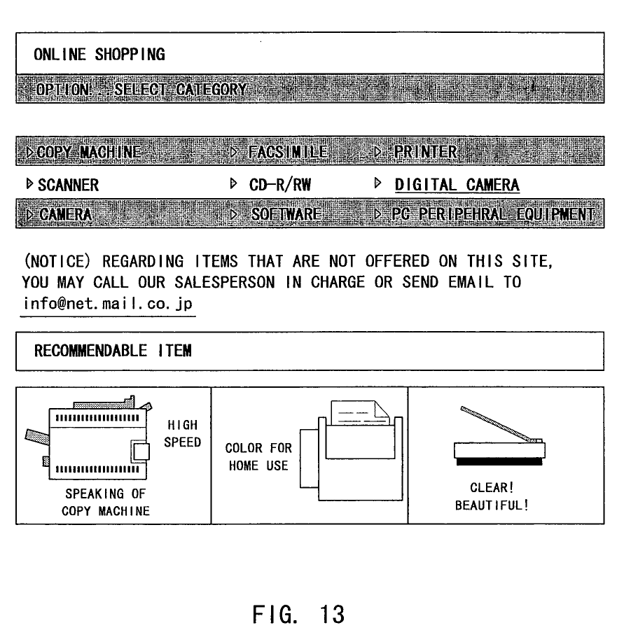

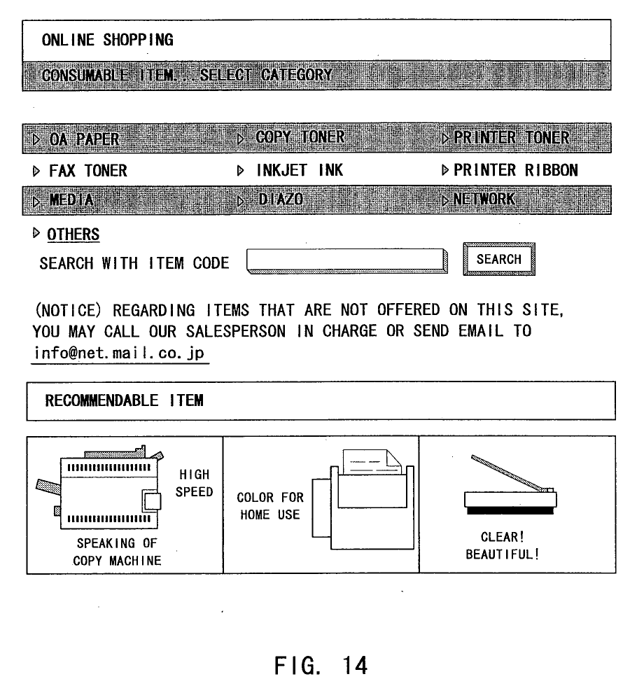

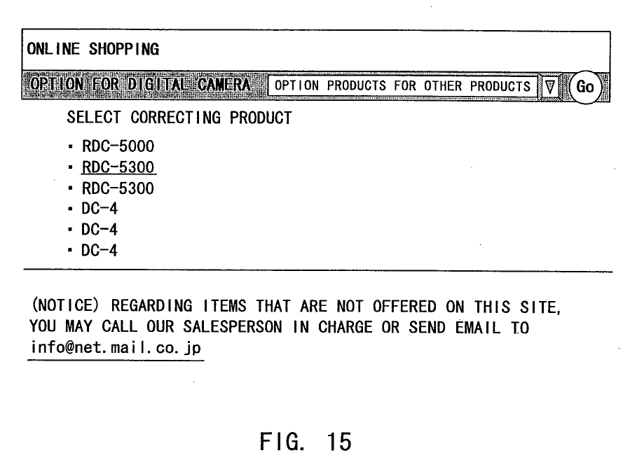

Similarly, when the user wishes to purchase the “option” or “consumable item,” the user clicks the “option” or “consumable item” at the left frame shown in FIG. 10. The display is jumped to the page that handles the “option” or “consumable item” as illustrated in FIG. 13 or FIG. 14. When the user selects a category, the list of main items is displayed as illustrated in FIG. 15. When the user selects any one of the categories, the shopping server 15 draws an item belonging to this category, its explanation, and a reference price from the item DB 254. Next, the shopping server 15 obtains the discount rate d from the client classification acquired in step S13, and gains the explanation of each item and the offering price to this client (reference price×(1−discount rate)). After that, the shopping sever 15 combines information of each item read from the material DB 252 and the obtained offering price to generate the page formatted as illustrated in FIG. 12, and transmits the page to the client terminal 31 to be displayed.

Thus, there is prepared a plurality of routes to reach the item (mainly, option or consumable item) that the user wishes. A first route is as follows: The item classification is selected (left frame of FIG. 10)→the screen page for selecting the category of the main item (main item by the kind of item) is displayed (FIG. 13)→the category is selected→the list of the models of the main item belonging to the selected category is displayed→the model is selected→the list of items, which are applicable to the selected model and which belong to the selected item classification, is displayed→item selection.

A second mute is as follows: The item classification is selected (left frame of FIG. 10)→the screen page for selecting the category of the item (item by the kind of item), which belongs to the item classification, is displayed (FIG. 14)→the category is selected→the list of the items belonging to the selected category is displayed→item selection.

A third route is as follows: The main item is selected as an item classification (left frame of FIG. 10)→the category is selected→the list of main items is displayed→the suitable main item is selected and the item classification is specified→the list of options or consumable items applicable to the main item is displayed→item selection.

A fourth route is as follows: Specifically, the item classification is selected (left frame of FIG. 10)→the screen page for selecting the category of the main item (main item by the kind of item) is displayed (FIG. 11)→the category is selected→the list of the models of the main item belonging to the selected category is displayed (FIG. 12)→the item classification (option or consumable item) of the subordinate item is selected→the list of items, which are applicable to the selected model and which belong to the specified item classification, is displayed→item selection.

A fifth route is a method for specifying the item code (trade name is possible). When the item code is inputted to a predetermined input box and “search” is clicked, the shopping server 15 draws the corresponding item from the item DB 254 and displays it.

It is assumed that the user puts an arbitrary item in the shopping cart on any one of screen pages (namely, purchaser's intention is indicated).

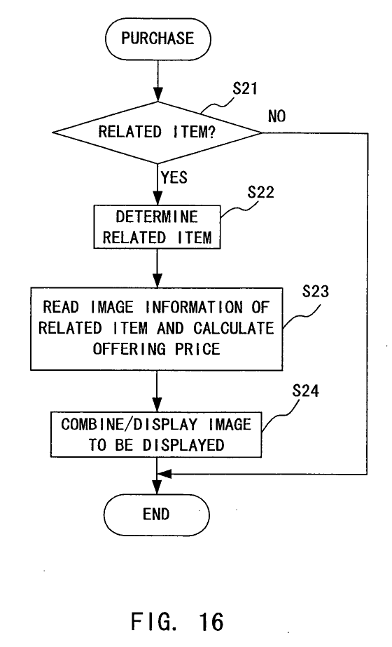

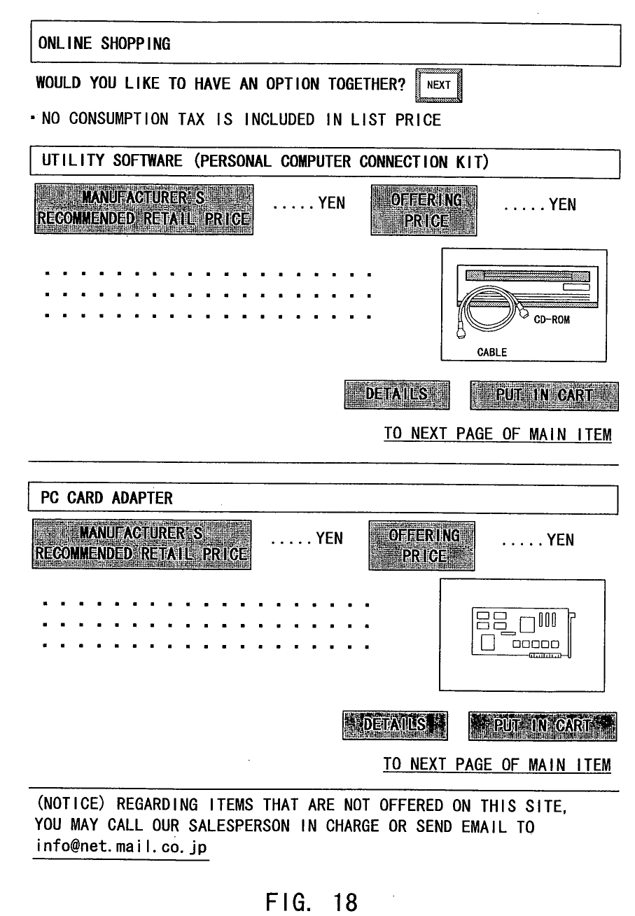

The shopping server 15 starts processing of FIG. 16, and determines whether or not the item put in the cart is registered in the related item DB 257 (step S21). When it is not registered, processing is ended directly. When it is registered, the shopping server 15 determines the item related to the item put in the shopping cart (step S22). The shopping server 15 reads image data of this item from the material DB 252, and calculates the offering price (step S23). The shopping server 25 further forms a display image, and displays it (step S24). Namely, the shopping server 15 displays the item, which should be purchased along with the item put in the cart, or the item (related item) having a strong tendency to be generally purchased at the same time, as illustrated in FIG. 18 to prevent the user from forgetting the order. The user judges whether the displayed item should be purchased or not to proceed processing.

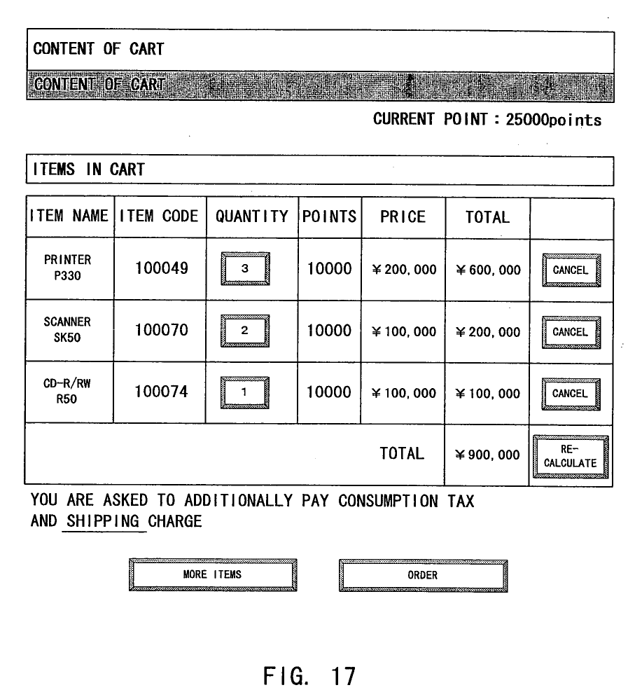

When the selection of the item is ended or during the process of selecting the item, the user can confirm the current purchase state as illustrated in FIG. 17 by referring to the page of “content of cart” appropriately. The shopping server 15 generates a screen page as illustrated in FIG. 17 based on the item where “put in cart” is specified, the quantity, and the price (offering price). In the case of ordering the item after confirming the content of the cart, the user clicks “to order procedure.” Then, the display to confirm a destination and the way of payment is mad based on the preliminary registration. When the user confirms the content and clicks “go,” the destination and the way of payment are confirmed and necessary processing is carried out respectively.

For example, an order sheet where information that specifies the purchased item, the number of items, the address, and the like is described is printed and outputted. Also, the purchased item and the purchase mode are red in the sales DB 255. This sales information is, for example, collected in the management DB 233 by batch processing on that night. The management server 13 updates information of the possessed apparatus of each user and information of the item to be sold at the same time based on collected data.

In the case where the purchaser is a corporation, it is necessary that the sales via the online shopping and the sales at the store in charge should be added up to make a bill. For this reason the management server 13 transmits sales information of the online shopping to the store in charge. The store adds information transmitted from the management server 13 into the bill for the client. At this time, a flag indicative of the sales via the online shopping is turned on (online? YES). As a result, each store terminal 11 issues a bill in which a charge for sales at the store and a charge for sales via the online shopping are mixed with respect to each client. It is noted that any format may be used as a bill. For example, the amount billed may be a total value in which the sales amount at the store and the sales amount via the online shopping are added to each other. Or, it is possible to clearly divide the amount billed into the charge for sales (billing statement) at the store and the billing statement via the online shopping.

The management server 13 checks, for example, the content of the sales master DB 234 periodically to update the content of the related item master DB 233. Namely, the management server 13 checks the sales history within a fixed period of time, which is registered in the sales master DB 234, and extracts the item sold at the same time. Then, by use of statistical processing, the management server 13 extracts a combination of items with 5% or more of a reference value indicating probability that the other item will be sold when one item has been sold. After that, the management server 13 registers the extracted combination of items into the related item master DB 233. The necessary part of the updated related item master DB 233 is duplicated to the related item DB 257 of the shopping DB 25 and is checked when the user puts a certain item in the shopping cart via the online shopping,

As explained above, according to this embodiment, the user can enjoy the online shopping service while enjoying the service at the existing store/service shop or the service of the door-to-door sales. In addition, the content of the service such as the discount rate set with respect to the client by the transaction at the store can be used in the online shopping. This system judges the consumable item and the option product which are applicable to the item that the user possesses, based on the user's purchase history, and shows the result to the user. Accordingly, the user can purchase the consumable item and the option without conducting a complicated procure. Moreover, the selection of an item can be easily carried out at the time of purchasing the consumable item and the option. Moreover, since the related item is shown at the time of purchasing some item, an omission of purchase can prevented.

Furthermore, in the case of a corporation (the terms “corporate” and “corporation” are used herein to refer generally to business organizations), an ID (corporation ID) is added to the business organization itself as information used at the time of logging in, and an ID and a password for the person in charge of the purchase are further set in the corporation ID. Generally, in the case where the ID and the password are added to the corporation and they are simply used in the corporation, information is easily leaked outside and this will cause a third person bearing ill will to commit an illegal act. According to this embodiment, however, since the password is the individual password for the person in charge of the purchase, there is a low possibility that the ID and the password will be leaked outside. A distinction can be clearly made between the purchase of the item as a corporate person in charge and the purchase of the item as an individual.

In a case where the business organization having the business transaction at the sales store network purchases the item via the online shopping, the charge for the item is issued from the sales store. This makes it possible to free the client the inconvenience of receiving the charge from two places.

### Second Embodiment

Information that the user, who has gained access to the network, needs or wishes differs depending on the attribute (for example, official position in the company) of the user. The following will explain the configuration of the network system that is capable of carrying out a suitable display for the user depending on the attribute of user.

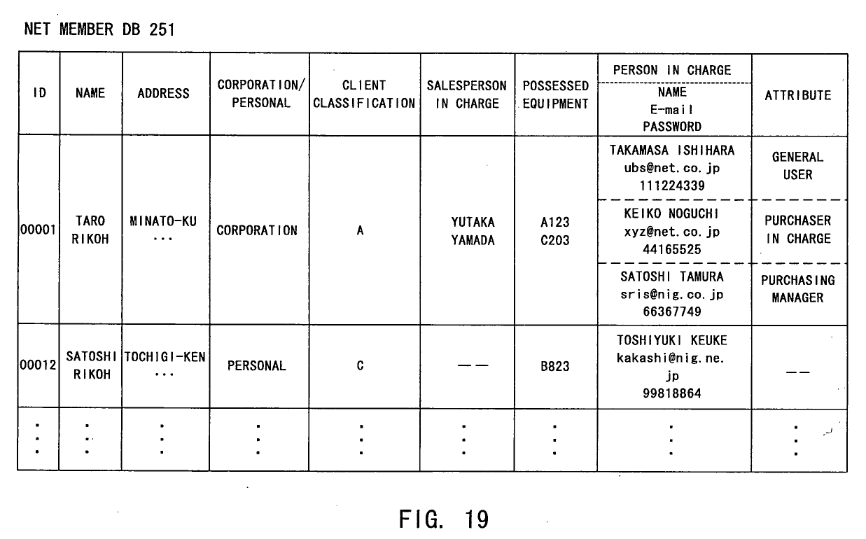

According to this embodiment, in the case where the user is a corporation, the attributes of the respective persons in charge are stored in the net member DB 251 in addition to the name of the person in charge of the corporation and mail address as illustrated in FIG. 19. The attribute refers to one of “general user,” “person in charge of purchase,” “purchase manager,” and “managerial staff.” Herein, the “general user” is a person in charge of operating or using the office equipment in accordance with the needs of the business. The “person in charge of purchase” is a person who takes charge of the purchase relating to equipment in business. This includes, for example, a person in charge of general affairs that orders the consumable item less than the fixed price or a person in charge of facilities. The “purchase manager” is a person who manages the budget or expense of the corporation or the department. The “managerial staff” is a person in charge of the top management of the corporation and the department.

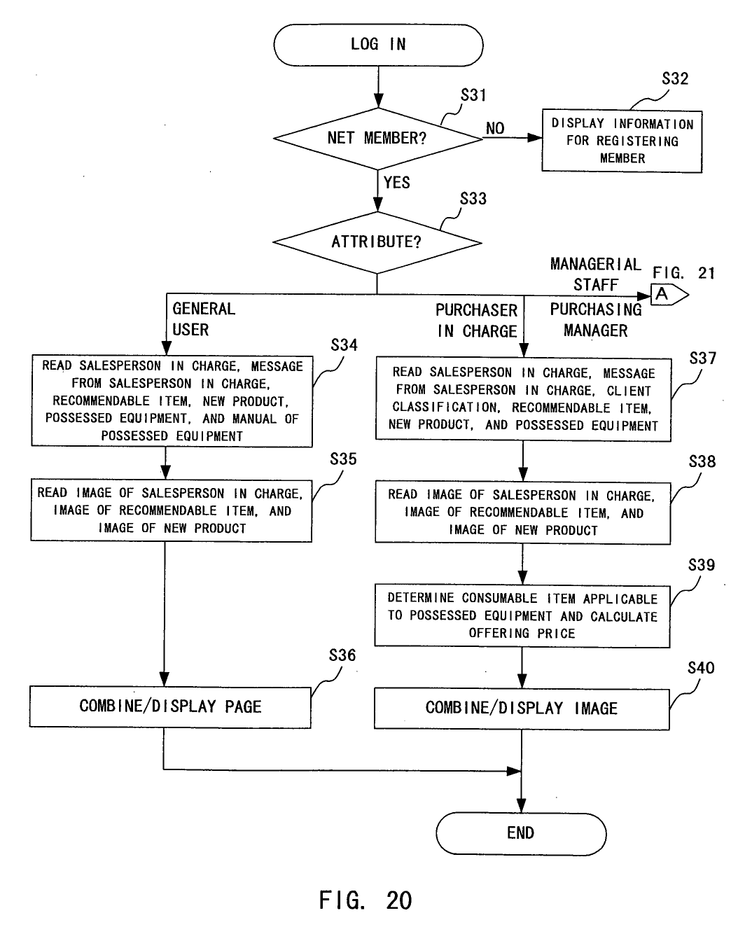

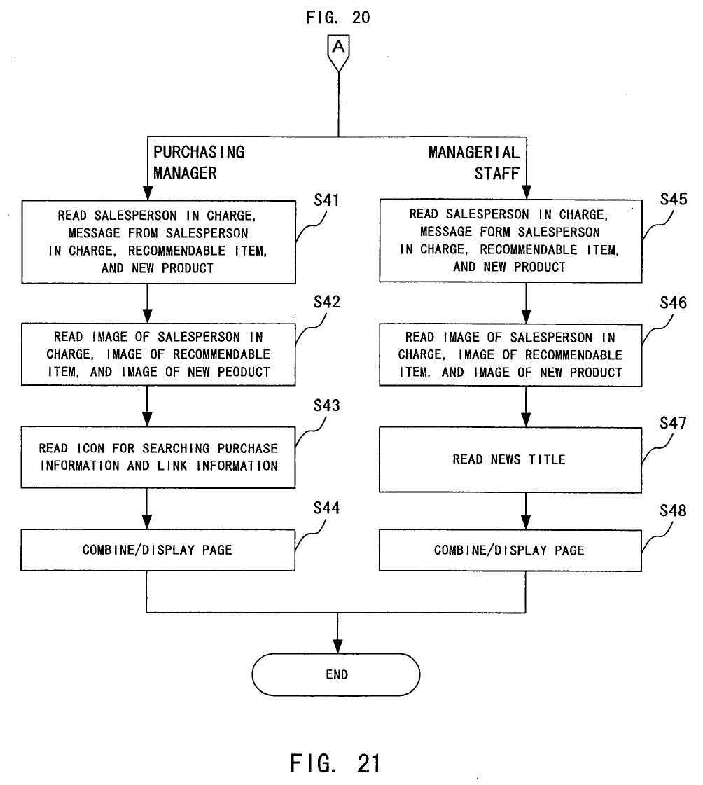

When the user inputs the mail address, password, and corporation ID into the log-in page illustrated in FIG. 8 and clicks “transmits” the shopping server 15 starts processing as illustrated in FIG. 20 to determine whether or not the pair of the input ID and mail address is registered in the net member DB 251 (step S31). This processing is substantially the same as that of step S11 of FIG. 9.

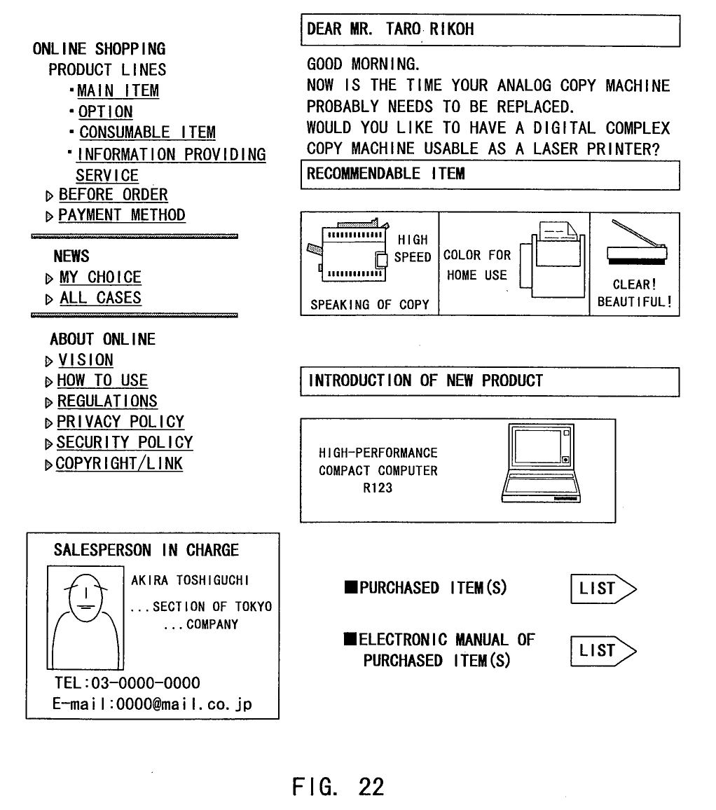

When the pair of input information is not registered in the net member DB 251, the shopping server 15 transmits a page for guiding a registration procedure to the client terminal (step S32). When the pair of input information is registered in the net member DB 251, the shopping server 15 determines the attribute of user who has accessed from the content of net member DB 251 (step S33). Then, the shopping server 15 determines that the attribute is the “general user,” the shopping server 15 reads the salesperson in charge of this client at the store, message from the salesperson in charge, recommendable item, new product, user's possessed apparatus, and manual of possessed apparatus from the net member DB 251 (step S34). Net, the shopping server 15 reads an image of the salesperson in charge read in step S13, an image of recommendable item, and that of new product from the material DB 252 (step S35). After that, the shopping server 15 generates page information (for example, HTML document) as illustrated in FIG. 22 based on data read in step S35, and transmits the generated page information to the client terminal 31 to be displaced (step S36). This page information includes an icon for searching the message from the salesperson in charge, recommendable item, new product, and user's possessed apparatus, and an icon for searching the operation manual of user's possessed apparatus.

When the shopping server 15 determines that the attribute is the “person in charge of purchase” in step S33, the shopping server 15 reads the salesperson in charge of this client at the sales store, message from the salesperson in charge, client classification, recommendable item, new product, and possessed apparatus from the net member DB 251 (step S37). Next, the shopping network 15 reads the image of the salesperson in charge, that of recommendable item, and that of new product read in step S37 from the material DB 252 (step S38). After that, the shopping network 15 determines a consumable item applicable to the apparatus that the logged-in member possesses from information relating to the possessed apparatus read in step S37 and related information recorded on the related item DB 257, and reads information relating to the consumable item from the material DB 252. Moreover, the shopping server 15 obtains a discount rate d corresponding to the client classification read in step S37 and further obtains an offering price considering the discount rate (reference price×(1−d)) (step S39).

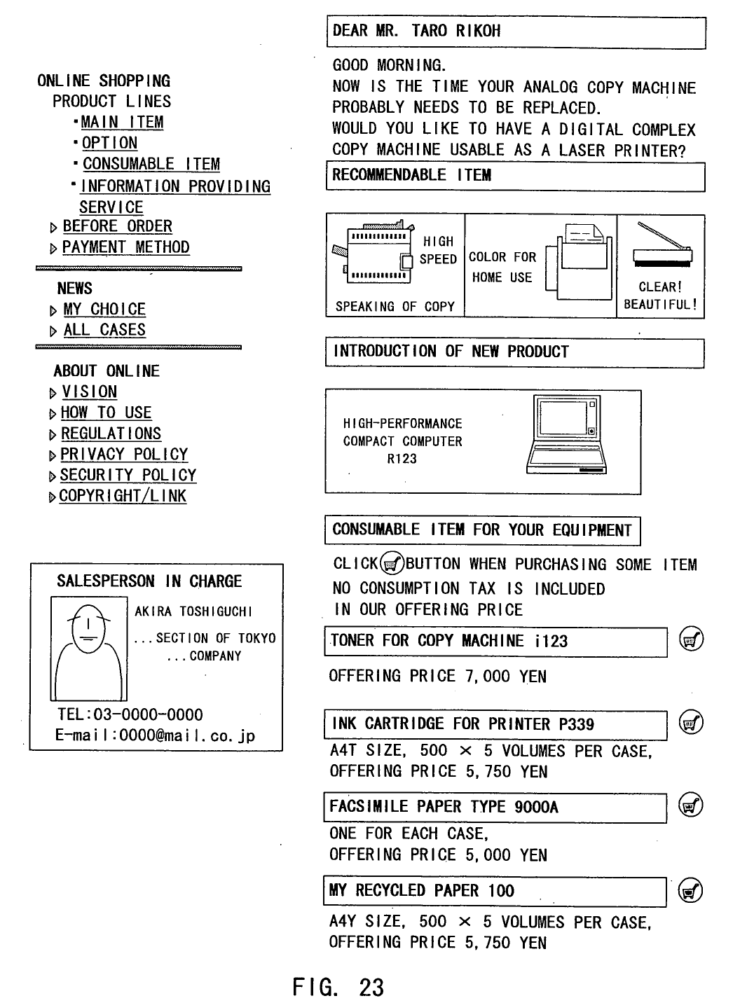

Next, the shopping server 15 generates page information (for example, HTML document) as illustrated in FIG. 23 based on the above information, and transmits the generated page information to the client terminal 31 to be displayed (step S40). This page information includes the message from the salesperson in charge, recommendable item, new product, list of consumable items relating to the item that the user possesses, icon for purchase, and so on. Accordingly, the person in charge of purchase can order the consumable item (toner, ink, paper, and the like) on the page as required.

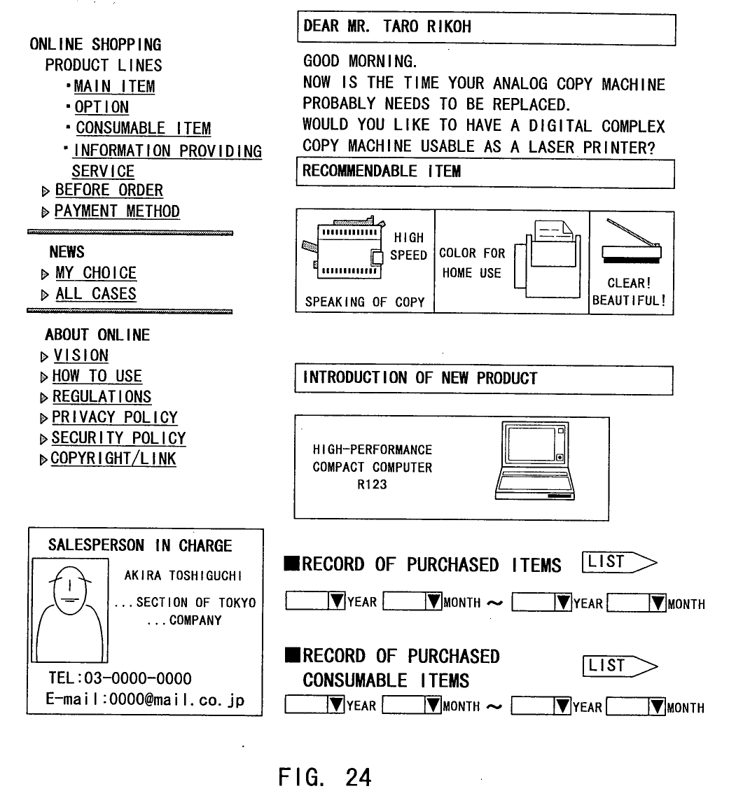

When the shopping server 15 determines that the attribute is the “purchase manager” in step S33, the flow goes to step S41 of FIG. 21 and the shopping server 15 reads the salesperson in charge of this client at the sales store, message from the salesperson in charge, recommendable item, and new product firm the net member DB 251 (step S41). Next, the shopping server 15 reads the image of the salesperson in charge, that of recommendable item, and that of new product read in step S41 (step S42). The shopping server 15 further reads an icon for linking to a page for searching purchase information (purchase apparatus, purchase consumable item) and link information (step S43). After that, the shopping sever 15 generates page information as illustrated in FIG. 24 based on the above information, and transmits the generated page information to the client terminal 31 to be displayed (step S40). This page information includes basic information of new product and commendable product, information of option, and information of order, and an icon for search and accumulation.

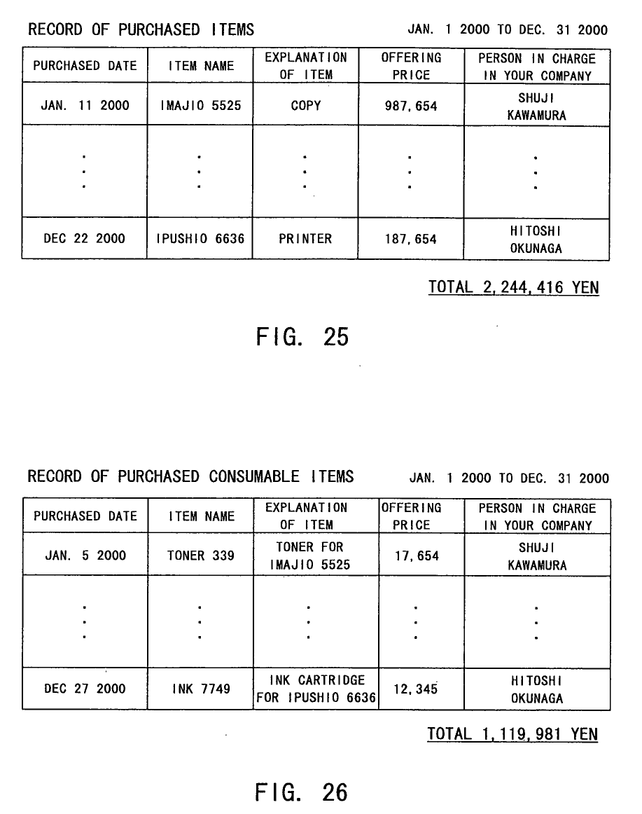

When the purchase manager specifies a suitable period of time and clicks the icon for search and accumulation, a page for search and accumulation as illustrated in FIG. 25 is opened, and the person in charge displays the list of apparatus/consumable items purchased in the past, the list of expenses, and the sum total. When the purchase manager inputs necessary matters into this page and clicks “transmit,” the shopping server 15 searches the sales DB 255, extracts the corresponding information to generate page information (HTML document), and provides it to the user terminal 31. This configuration makes it possible for the purchase manager to obtain the purchase item, information of expenses, which are useful information to execute the manager's duty.

When the shopping server 15 determines that the attribute is the “managerial staff” in step S33, the shopping server 15 reads the salesperson in charge of this client at the sales store, message from the salesperson in chare, recommendable item, and new product from the net member DB 251 (step S45). Net, the shopping server 15 reads the image of the salesperson in charge, that of recommendable item, and that of new product read in step S13 from the material DB 252 (step S46).

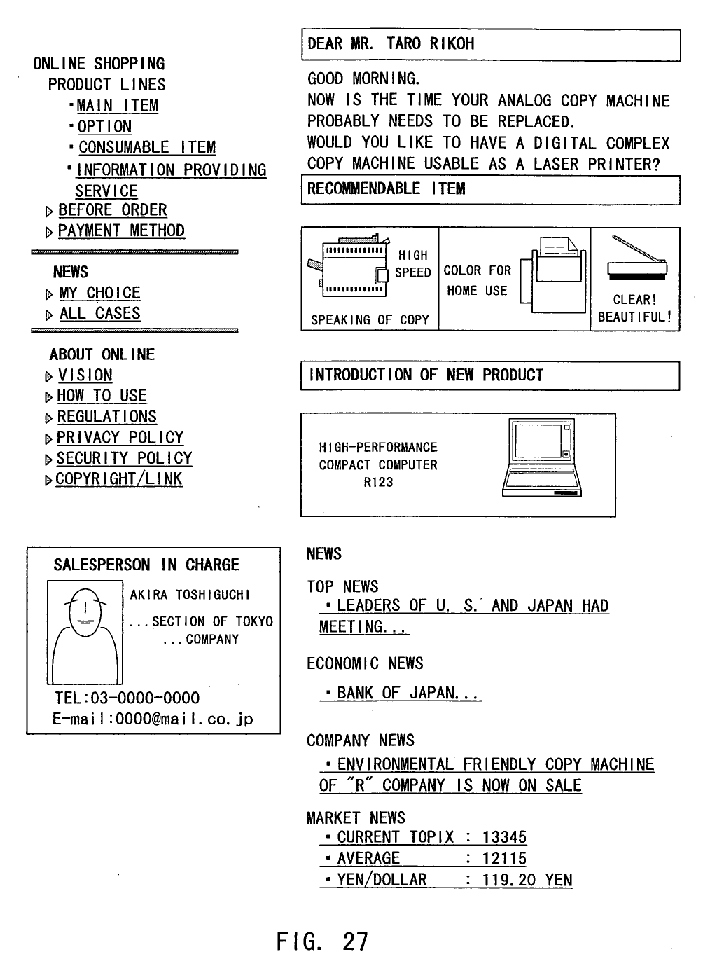

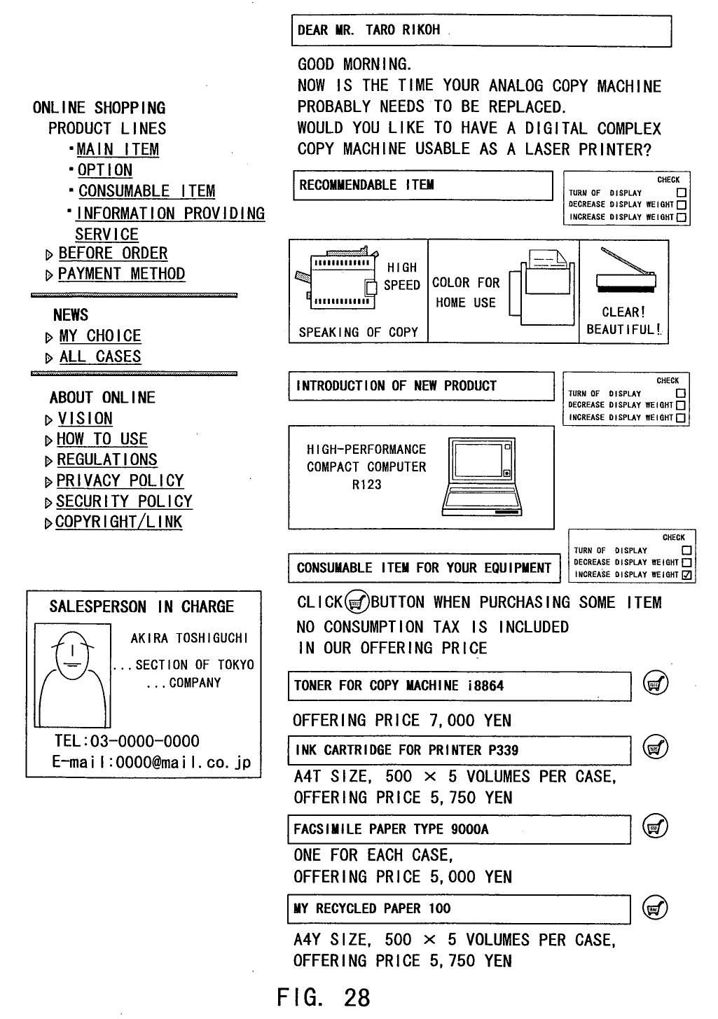

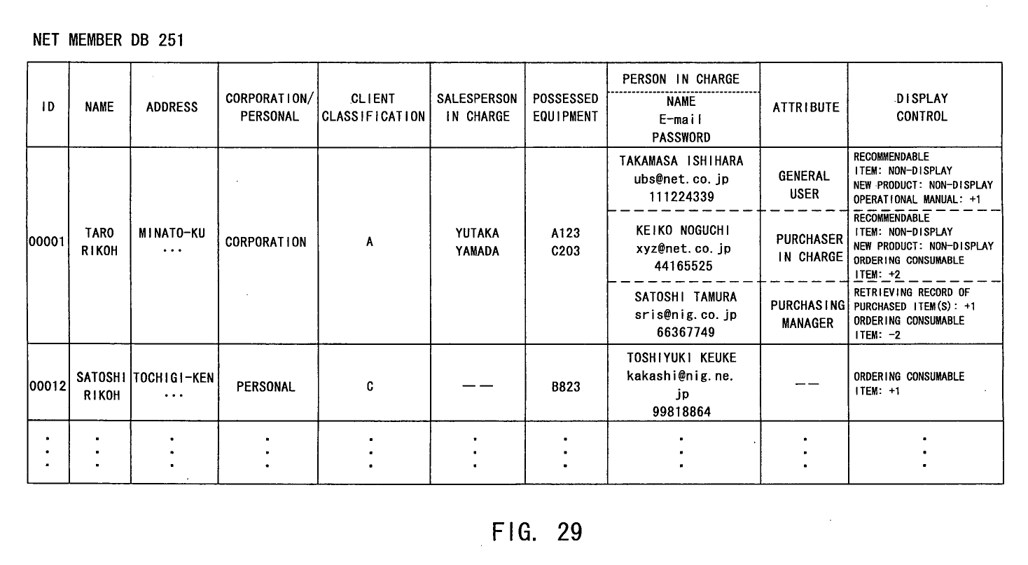

Sequentially, the shopping server 15 obtains a title such as a top new, economic news, stock information, information of exchange rate, etc., from news DB 259 (step S47). Then, the shopping server 15 generates page information as illustrated in FIG. 27 based on the above information, and transmits the generated page information to the client terminal 31 to be displayed (step S40). When the corporate manager clicks an interesting title, the page linked thereto is opened, and the content of the news is displayed. According to this configuration, information corresponding to (useful for executing the duty) the attribute (duty in this example) of the person who has gained access to this online shopping system is displayed on the top page. Accordingly, information provided by the shopping server 15 can be sufficiently used without being wasted.

It is noted that the content of information to be displayed depending on the attribute is arbitrary. For example, in displaying “Message” from the salesperson in charge, the content of display may be changed depending on the attribute. In this case, each salesperson in charge generates four messages depending on the attribute. Each message is stored in the net member DB 251 by batch processing. At the time of reading the message in steps S34, S37, S41, and S45, the shopping server 15 selectively reads the message corresponding to the attribute determined in step S33 to generate page information.

Moreover, the user may adjust the display weight of the content placed on the page thus provided according to the attribute. For example, a checkbox for specifying the user's intention relating to the display weight may be added to the display item such as recommendable item, new product, consumable item information, and the like. The checkbox includes a display rejection checkbox for setting information to non-display next time, a “display minus” checkbox for displaying the display content at a lower position than the current display position and a “display plus” checkbox for displaying the display content at an upper position than the current display position.

For example, when the user does not wish to display information relating to the recommendable item next time, the user places a checkmark in the display reaction checkbox. When the user wishes to move the display for a manual search to the upper position, the user places a checkmark in the display plus checkbox. Moreover, when the user wishes to move the display for new product information and recommendable information to the lower position, the user places a checkmark in the display minus checkbox.

The above information is registered onto the net member DB 251 as display control information by person in charge as illustrated in FIG. 29. In the above example, the recommendable item is set to non-display and the degree of priority relating to the manual search is incremented by +1 (when the original is a default (0), the value is set to +1 and when the original is +1, the value is set to +2), and the degree of priority relating to new product information or recommendable information is decremented by −1.

When combining the pages in steps S36, S40, S44, and S48 of FIGS. 20 and 21, the shopping server 15 refers to the column of display control corresponding to the user, who has gained access, and controls the position of the content to be placed in accordance with the setting, and combines the pages. This configuration makes it possible to appropriately set the display format according to the user's favorite and necessity.

The present invention is not limited to the aforementioned embodiments, and various modifications and applications are possible. For example, in the above-mentioned embodiments, the sales store system for selling the articles and the online shopping system are combined, but the selling object is arbitrary. For example, the same system may be applied to the sales store system for providing digital contents (image, music and so on) and service and the online shopping system.

According to the above-mentioned embodiments, the items are classified into “main item,” “option,” and “consumable item.” The classification system is, however, arbitrary. The items may be arbitrarily classified into the item as a main item and the item, which is subordinate thereto.

The configuration of the server and that of DB are arbitrary changeable. For example, FIGS. 1 and 2 explained that one store terminal 11 was installed at each store in order to make the understanding easy. According to the present invention, a plurality of store terminals connected to LAN may be installed at each store. Regarding the management server 13 and the shopping server 15, they may be also composed of a plurality of servers operated in cooperation with each other. Moreover, the configuration of DB is not limited to the above-explained configuration, and two or more DBs may be combined. Or, one DB may be divided into a plurality of functions. In addition, overlapping data may be deleted. For example, in the above-mentioned embodiments, the relationship among the main item, option and consumable item is not set in the related item master DB 233, and the relationship may be specified from the content of the item master DB 231.

Also, information of the related item may be processed by the related item DB 257 without providing the related item master DB 233. Similarly, link information of item may be provided to only the item DB 254 without providing it to the item master DB 231.

Furthermore, in the aforementioned embodiments, the recommendable item and the message stored in the client DB 211 by the salesperson of each sales store were posted on the home page. The salesperson may directly access the shopping DB 25 to register the recommendable item and the message. Emil describing such information may be transmitted to the shopping server, and a necessary matter may be fetched from e-mail and posted on the home page.

Still furthermore, the discount rate based on the client classification may be made different in the store sales and the online shopping.

The computer and the computer group may be functioned as the aforementioned system, or the entirety or the part of the program necessary for executing the above-mentioned processing may be recorded on the recording medium (ROM, floppy disk, hard disk, CD-ROM, MO, CD-R, flash memory and the like) to be distributed/circulated. A program for realizing the functions of the computer can be embodied in a carrier wave, transmitted from another computer apparatus (not illustrated) through the Internet, received by a communications device, and stored in a memory.

As explained above, according to the present invention, it is possible to appropriately recommend the item related to the item that the client possesses.

Various embodiments and changes may be made to the preferred embodiments without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention

This application is based on Japanese Patent Applications Nos. 2000-73679, 2000-73684, 2000-73690, and 2000-73693, filed on Mar. 16, 2000, and No. 2001-464347, filed on Mar. 8, 2001, and including specification, claims, drawings and summary. The disclosures of the above Japanese patent applications are incorporated herein by reference in the entirety.

1-40. (canceled)

41. An item recommending method via computer network comprising:
providing online shopping site accessible via said computer network;
preparing item information representing relationship among a plurality of items to be sold on the online shopping site;
accepting access to the online shopping site via said computer network;
providing online shopping page having various routes to find items;
accepting designation of the items found on the online shopping page via said computer network;
registering client information if the accessing user is unregistered user;
specifying recommendable items related to the designated items or previously registered recommendable items being associated with client information of the client concerned;
providing recommendation information representing the specified recommendable items with the client concerned, via said computer network; and
registering information representing the specified recommendable items so as to be associated with the client information of the client concerned.

42. The item recommending method via computer network according to claim 41, wherein,
said online shopping page provides a route for finding desired items, including the steps of:
showing classification items;
showing categories of main items which belong to a selected classification;
showing a list of models of main items which belong to a selected category; and
showing a list of items which relating to a selected main item model and belonging to the selected category.

43. The item recommending method via computer network according to claim 41, wherein,
said online shopping page provides a route for finding desired items, including the steps of:
showing classification of items;
showing categories of items which belong to a selected classification; and
showing a list of items which belong to a selected category.

44. The item recommending method via computer network according to claim 41, wherein,
said online shopping page provides a route for finding desired items, including the steps of:
showing categories corresponding to main items selected as desired item classifications;
showing a list of main items;
specifying item classification corresponding to a selected main item; and
showing a list of options or consumable items applicable to the selected main item.

45. The item recommending method via computer network according to claim 41, wherein,
said online shopping page provides a route for finding desired items, including the steps of:
showing categories of main items corresponding to a selected item classification;
showing a list of models of main items belonging to a selected category with showing subordinate item classifications corresponding to each of the listed main items;
showing a list of items applicable to a selected main item while belonging to a designated subordinate item classification.

46. The item recommending method via computer network according to claim 41, wherein,
said online shopping page provides a route for finding desired items, including the steps of:
accepting item code or item name input by the client;
accessing a database to find item information corresponding to items being associated with the input item code or item name; and
showing the found item information.
